(19) United States
(12) Patent Application Publication
(10) Pub. No.: US 2010/0062215 A1
(43) Pub. Date: Mar. 11, 2010

(54) Component having through-hole and method of manufacturing component

(75) Inventor: Tamotsu Iida, Ibaraki-shi (JP)

Correspondence Address: OLIFF & BERRIDGE, PLC, P.O. BOX 320850, ALEXANDRIA, VA, 22320-4850, US

(73) Assignee: HITACHI MAXELL, LTD., IBARAKI-SHI (JP)

(21) Appl. No.: 12/585,149

(22) Filed: Sep. 4, 2009

(30) Foreign Application Priority Data
Sep. 9, 2008 (JP) 2008-230811

(51) Int. Cl. B32B 3/10

(52) U.S. Cl. 428/137; 264/104

(57) ABSTRACT

In accordance with an exemplary aspect of the present invention, a method of manufacturing a component includes forming a resin block by a resin molding method such that a peripheral region including a region where a through-hole is formed is formed as a convex portion in one of front and back surfaces, and the other surface has a hole in a region where the through-hole is formed, removing the convex portion so that the hole completely penetrates the resin block, forming a conductive film on an exposed surface of the resin block, and electrically connecting conductive films formed on the front and back surfaces of the resin block.

### BACKGROUND OF THE INVENTION

1. Field of the Invention

The present invention relates to a component having a through-hole and a method of manufacturing the component.

2. Description of Related Art

In components for high-frequencies, as the used wavelength becomes shorter, the precision required in their manufacturing technology becomes more stringent. To wirelessly transmit high-vision images without compressing them, the use of millimeter waves has been proposed. Wireless HD standards were established as the universal standards in January 2008 in IEEE802.15.3c.

As its background, there has been a situation that specific low-power requiring no radio-station license is internationally assigned to 60 GHz bands among the millimeter wave range, and that widespread use for consumers and its preparation have been arranged.

When the frequency becomes higher like the millimeter waves, the wavelength becomes shorter to the order of 5 mm. Therefore, precision in the order of micrometer is required in the structural sizes of filters and antennas. In the case of antennas, in particular, array antennas in which a plurality of antenna elements are arranged in array for the phase synthesis, it is important to control the phase and gain of each element. Therefore, it is necessary to accurately control the positions and sizes of the antenna elements. If the elements themselves are very small but their precision cannot be properly maintained, the antenna does not function satisfactorily as an array antenna.

In millimeter-wave components, dielectric loss, conductor loss (copper loss), and radiation loss become significant whereas they do not cause any substantial problems in the microwave range. Therefore, it is also necessary to carefully examine the interface state between the dielectric material and the conductors (conductive films) and the material characteristics from the point of the losses.

Depending on the manufacturing method, there is a possibility that required accuracy and uniformity cannot be obtained, and thus making it impossible to obtain a component that can satisfy characteristics as a passive circuit component (passive component). The manufacturing method could be changed depending on the choice of the material, and the accuracy of the manufacturing could be also changed with the change in the manufacturing method, and thus affecting the mass-production efficiency and the yield.

For example, components used in millimeter-wave ranges have been manufactured in the conventional printed-circuit substrate manufacturing process. The process is briefly explained hereinafter. A photoresist is applied on a dielectric substrate on which copper is stuck in advance, and exposed to light. After the exposure, the photoresist is developed so that the resist remains only on the circuit pattern, and the exposed copper is etched so that the patter is formed.

The etching is performed with ferric oxide. However, the etching rate is changed depending on the temperature and concentration of the etching solution and the etching time. Therefore, stirring during the etching and the control of the etching solution are important. The time during which the substrate is submerged in the etching solution eventually determines the amount of the etching.

Strictly speaking, the size of the pattern affects not only the resist coating but also the above-mentioned etching conditions. Therefore, it is difficult to achieve a uniform pattern size with high yield rate when the pattern is formed in a large area.

From this background, manufacturing methods of passive circuit components for high-frequencies that are effective for mass production for consumer use and have excellent characteristics and high yield rate have been proposed (Japanese Unexamined Patent Application Publication Nos. 2003-115718, 2004-15833, and 2004-48801).

An antenna for millimeter waves is often formed by arranging patch antennas in array on a Teflon (registered trademark) substrate. However, the accuracy of each component is important in the array antenna as described above. Therefore, there is a problem that if circuit components are to be formed in a large area, the yield rate deteriorates in circuit patterns for millimeter wave ranges having short wavelengths. Further, since there is an upper limit to the size of an etching area, it has been very difficult to manufacture a number of components simultaneously, and thus causing a problem in the mass productivity.

Further, Teflon (registered trademark) substrates are generally expensive. Therefore, if the mass productivity is low and the yield rate is also low, the production cost increases.

When a pattern is formed as a circuit component, e.g., when a filter or a coaxial structure is implemented by a micro-strip line, a circuit pattern on the front surface is often paired with a ground surface on the back surface. The micro-strip line is composed of a ground on the back surface, a pattern on the front surface, and a dielectric interposed therebetween. However, the ground surface may be also provided on the front surface. Since the pattern and the ground surface constitute a circuit, the ground pattern on the front surface needs to be electrically connected with the ground surface on the back surface. To that end, a through-hole(s) is formed, and it is formed as a via(s) in a circuit for the microwave range.

In the case of Teflon (registered trademark) substrates, the through-hole is formed by drilling a hole in a patterned portion, i.e., a portion covered with a conductive film on each of the front and back surfaces, and the hole is further processed so that the inside of the hole is also covered with an conductive film. The conductive film on the inside of the hole is formed by electrolytic plating or sputtering or the like so that the conductive film on the front surface is electrically connected with the conductive film on the back surface.

The drill is typically processed by a machine such as an NC (Numerical Control) machine, and the drilling process is performed for each hole. The accuracy of the hole depends on the accuracy of the NC machine and the like, and in general it is very difficult to ensure accuracy in the order of several tens micrometers.

Although the manufacturing methods disclosed Japanese Unexamined Patent Application Publication Nos. 2003-115718, 2004-15833, and 2004-48801 can provide high accuracy and high mass productivity for circuit patterns. However, no through-hole is formed in the components in these manufacturing methods. Therefore, to provide through-hole structures like the ones required in the micro-strip lines, they require a drilling process as in the case of the Teflon (registered trademark) substrates. However, the drilling process is performed after the molding. That is, through-holes cannot be formed in the same manufacturing process as that of the pattern, and thereby causing a problem in terms of positional accuracy and mass productivity.

### SUMMARY OF THE INVENTION

An exemplary object of the present invention is to provide a component having a through-hole with high accuracy and high mass-productivity, and a method of manufacturing the component.

In accordance with an exemplary aspect of the present invention, a method of manufacturing a component having a through-hole includes: forming a resin block by a resin molding method such that a peripheral region including a region where a through-hole is formed, and a region where a circuit pattern is formed or a peripheral region other than a region where the circuit pattern is formed are formed as a convex portion or a concave portion in one of front and back surfaces, and the other surface has a hole in a region where the through-hole is formed, an end portion of the hole being accommodated within a convex portion of the region; removing the convex portion so that the hole completely penetrates the resin block; forming a conductive film on an exposed surface of the resin block; and removing the conductive film so that an end face of the convex portion is exposed, and electrically connecting conductive films formed on the front and back surfaces of the resin block through the through-hole. In this way, the formation of the circuit pattern and the formation of the though hole can be simultaneously performed. In addition, since the component is manufactured by a resin molding method, it is possible to mass-produce components having highly-accurate circuit patterns and through-holes. The circuit pattern is formed as a convex portion or a concave portion.

Preferably, a concave portion is formed in advance on the end face of the convex portion, within which the end portion of the hole is accommodated, the concave portion being configured to connect the inner peripheral edge of the end face with the outer peripheral edge of the end face when the hole completely penetrates the resin block. Further, the conductive film formed on the end face of the convex portion is preferably removed such that some of the conductive film remains in that concave portion. The resin block is preferably formed by an injection molding method, a nano-imprint method (thermoforming, exposure molding), or a thermal embossing method. Preferably, a circuit pattern is formed on the front and back surfaces of the resin block as a convex portion or a concave portion.

Another exemplary embodiment in accordance with an exemplary aspect of the present invention is a component having a through-hole, wherein: the resin block is formed by a resin molding method; in one of front and back surfaces of the resin block, a peripheral region including a region where a through-hole is formed is formed as a convex portion; a through-hole is formed within the convex portion; and conductive films formed on the front and back surfaces of the resin block are electrically connected through the through-hole. By forming a through-hole by a resin molding method as described above, it is possible to mass-produce components having highly-accurate through-holes.

Preferably, a concave portion is formed on the end face around an opening portion of the through-hole in the convex portion, the concave portion being configured to connect the inner peripheral edge of the end face with the outer peripheral edge of the end face, and a conductive film is preferably formed in the concave portion. The resin block is preferably formed by an injection molding method, a nano-imprint method (thermoforming, exposure molding), or a thermal embossing method. The formed pattern functions as a circuit pattern.

The present invention can provide a component having a through-hole with high accuracy and high mass-productivity, and a method of manufacturing the component.

The above and other objects, features and advantages of the present invention will become more fully understood from the detailed description given hereinbelow and the accompanying drawings which are given by way of illustration only, and thus are not to be considered as limiting the present invention.

### BRIEF DESCRIPTION OF THE DRAWINGS

FIG. 1A is a lengthwise cross-section for explaining a method of manufacturing a component having a through-hole in accordance with an exemplary aspect of the present invention;

FIG. 1B is a plane view for explaining a method of manufacturing a component having a through-hole in accordance with an exemplary aspect of the present invention;

FIGS. 2A to 2C are schematic diagrams for explaining processes for forming a resin block by an injection molding method;

FIG. 3A is a lengthwise cross-section for explaining a method of manufacturing a component having a through-hole in accordance with an exemplary aspect of the present invention;

FIG. 3B is a plane view for explaining a method of manufacturing a component having a through-hole in accordance with an exemplary aspect of the present invention;

FIG. 4A is a lengthwise cross-section for explaining a method of manufacturing a component having a through-hole in accordance with an exemplary aspect of the present invention;

FIG. 4B is a plane view for explaining a method of manufacturing a component having a through-hole in accordance with an exemplary aspect of the present invention;

FIG. 5A is a cross-section taken along the line VA-VA of FIG. 5B;

FIG. 5B is a plane view of a finished component manufactured by a method of manufacturing a component having a through-hole in accordance with an exemplary aspect of the present invention;

FIG. 6A is a cross-section taken along the line VIA-VIA of FIG. 6B;

FIG. 6B is a plane view of a finished component manufactured by a method of manufacturing a component having a through-hole in accordance with an exemplary aspect of the present invention; and

FIG. 7 is a figure for explaining height relation between convex portions.

### DESCRIPTION OF THE PREFERRED EMBODIMENTS

Exemplary embodiments of a component having a through-hole and a method of manufacturing the component in accordance with an exemplary aspect of the present invention are explained hereinafter with reference to the drawings. Note that some parts of the following explanation are simplified for the sake of convenience.

An exemplary object of the present invention is to manufacture a passive circuit and a passive component, such as an antenna having a through-hole for constituting a radiation opening slot or a waveguide structure, and a micro-strip antenna having a through-hole for electrically connecting a circuit pattern of a strip conductor and the strip conductor itself with a ground conductor, by a resin molding method. Basically, a publicly-known resin molding method may be used as means to form a circuit pattern. At this point, to form a through-hole, it is necessary to form a hole completely penetrating the substrate. Therefore, it is necessary to form even a through-hole by the resin molding method in order to achieve highly-accurate pattern formation by the molding process, which is an exemplary object of the present invention.

However, piercing the substrate using a forming die involves a problem in terms of accuracy of the alignment of the metal die and manufacturing of the metal die, and therefore it is very difficult. For example, it is possible to form a through-hole by an imprint method, i.e., by pressing a forming die of a through-hole on the substrate. However, since the through-hole has a small diameter, the convex portion for forming the through-hole in the forming die has also a small diameter. Therefore, the shape of the convex portion of the forming die is changed after the formation of a through-hole is repeatedly performed, and thus making it very difficult to form a through-hole with high accuracy. Further, when resin is pressed out and deposited on the receiving die, the shape of the forming die is also changed, and thus making it impossible to form a through-hole with high accuracy.

Alternatively, it is possible to form a though hole by using an injection molding method. However, the aspect ratio of the convex portion of the forming die becomes high. Therefore, when the die is to be removed after the molding, the resistance between the outer peripheral surface of the convex portion and the substrate is large. Consequently, a large external force is exerted on the root of the convex portion, and thereby the convex portion is deformed. Accordingly, it is very difficult to form a through-hole with high accuracy.

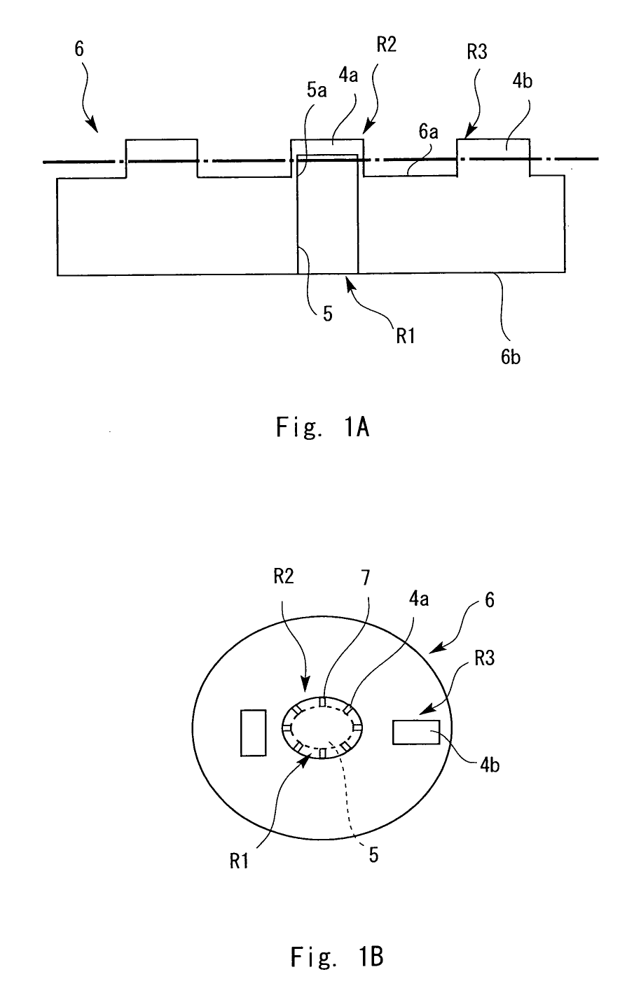

In an exemplary aspect of the present invention, the complete penetration of the substrate, which is causing the above-mentioned problem, is not carried out. Instead, a hole that will eventually become a through-hole is formed at first, and then that hole completely penetrates the substrate. As an example, a manufacturing process of a circuit component is explained hereinafter. In order to form a circuit component 1, firstly, as shown in FIGS. 1A and 1B, a resin block 6 is formed by a resin molding method. At this point, in the front surface 6a of the resin block 6, a peripheral region R2 including a region R1 where a through-hole 2 is formed and a region R3 where a circuit pattern 3 is formed are formed as convex portions 4 (4a and 4b). The resin block 6 has a hole 5 in its back surface 6b. The hole 5 is formed in a region where the through-hole 2 will be formed. An end portion 5a is accommodated within the convex portion 4a of that region. However, instead of the region where the circuit pattern 3 is formed, a peripheral region other than the region where the circuit pattern 3 may be formed as the convex portion 4. However, the circuit pattern 3 may be formed as a concave portion.

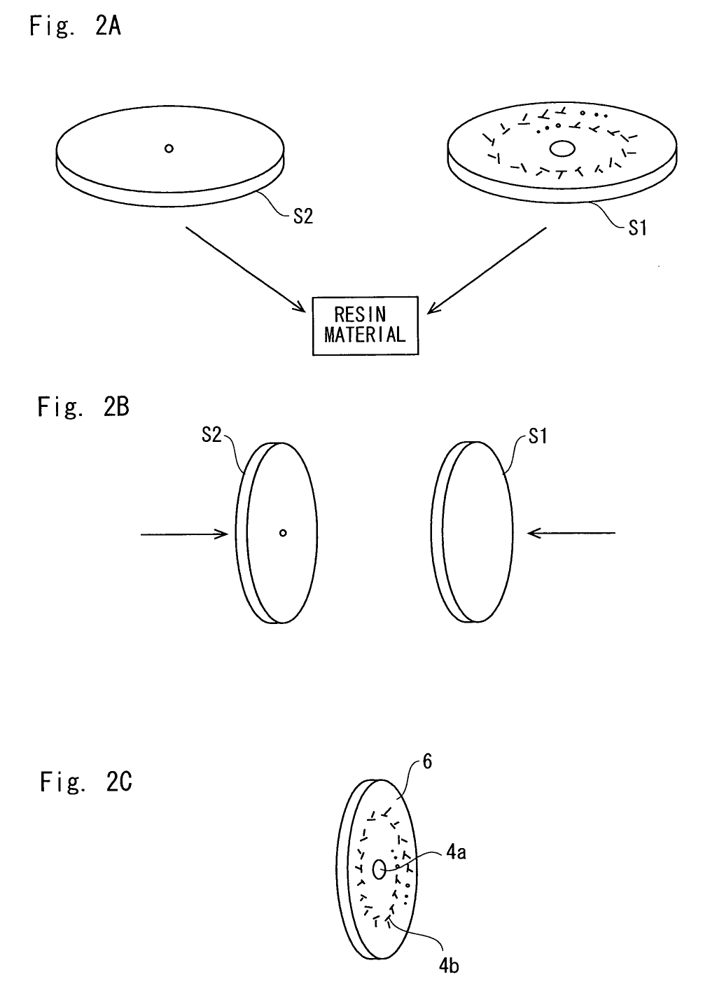

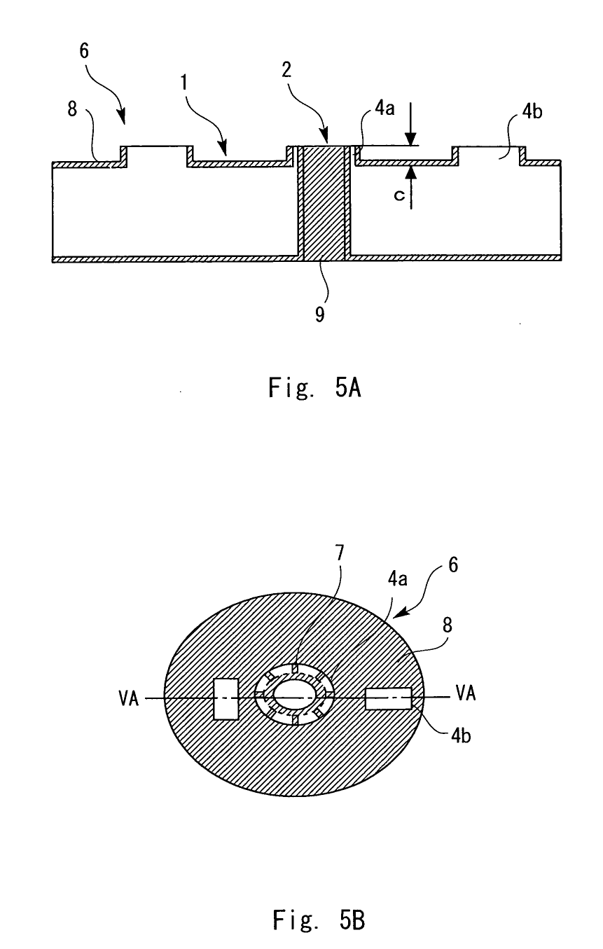

Specifically, a forming die S1 shown in FIGS. 2A and 2B is created. As shown in FIGS. 1A, 1B, 5A, and 5B, the forming die S1 forms a convex portion 4a in the peripheral region R2 including the region R1 where the through-hole 2 is formed in the front surface 6a of the resin block 6. Further, the forming die S1 also forms a convex portion 4b, for example, as a circuit pattern in the region R3 where a portion of the circuit pattern 3 of the resin block 6 is formed. Concave portions corresponding to convex portions 4a and 4b like these are formed in the forming die S1. Further, the forming die S1 also forms a plurality of concave portions 7, which will connect the inner peripheral edge of the upper end face of the convex portion 4a of the resin block 6 with the outer peripheral edge of the upper end face when the hole 5 completely penetrates the resin block, in a radial pattern on that upper end face of the convex portion 4a (though not limited to this configuration). Convex portions corresponding to concave portions 7 like these are formed in the concave portion of the forming die S1 that is used to form the convex portion 4a of the resin block 6. Meanwhile, a forming die S2 shown in FIGS. 2A and 2B is also created. The forming die S2 forms a hole 5 whose end portion 5a is accommodated within the convex portion 4a in the region R1 where the through-hole 2 is formed in the back surface 6b of the resin block 6. A convex portion corresponding to a hole 5 like this is created in the forming die S2.

These forming dies S1 and S2 are disposed with a gap corresponding to the predetermined thickness of the component therebetween. Then, after melted resin is injected into that gap portion and the resin is solidified, the forming dies are removed.

As a result, the resin block 6 is formed with high accuracy (FIG. 2C). At this point, the convex portions 4a and 4b are formed in predefined positions on the front surface 6a of the resin block 6. A hole 5 is formed in a predefined position on the back surface 6b of the resin block 6. The hole 5 has an inner diameter smaller than the outer diameter of the convex portion 4a. The hole 5 has such a depth that the bottom surface of the hole 5 is positioned lower than the top surface of the convex portion 4a and higher than lower portions of the front surface 6a.

It should be noted that to reduce the work necessary to remove the convex portion later, the distance between the bottom surface of the hole 5 and the upper end face of the convex portion 4a should preferably be made as small as possible. Note that FIGS. 2A and 2B illustrating the forming dies S1 and S2 is a figure for explaining an aspect of typical molding, and the pattern represents a circuit. However, the present invention is not limited to this pattern. Note also that the figure is not illustrating any pattern for forming a through-hole.

The resin block 6 can be also obtained by a pattern transcription method as well as by the injection molding method. Examples of the pattern transcription method include thermal imprint using heating and warming, and optical imprint using UV-curable resin, and either of the methods can be used. Needless to say, a resin block 6 can be also obtained by a nano-imprint method or emboss molding method or the like.

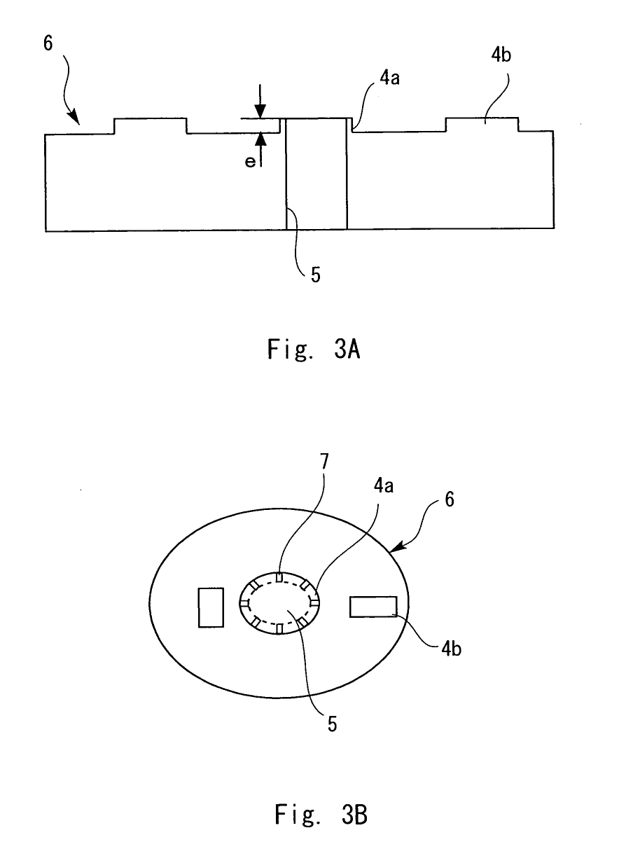

Next, to completely pierce the resin block with the hole 5, the convex portions 4a and 4b are ground or shaved to remove them to the dashed line shown in FIG. 1A. As a result, the portion between the upper end face of the convex portion 4a and the bottom surface of the hole 5 is removed, and consequently the resin block 6 is completely pierced from the front to back with the hole 5 (FIGS. 3A and 3B). At this point, the concave portions 7 remain on the upper end face of the convex portion 4a.

As described above, the hole 5 is formed to a predefined depth without completely piercing the resin block at once by the forming die S2 at first, and then the resin block is completely pierced with the hole 5 by removing the convex portion 4a. Therefore, it becomes possible to reduce the height of the convex portion for forming the hole 5 in the forming die S2, and thus making it possible to minimize the aspect ratio of that convex portion. Accordingly, it becomes possible to reduce the resistance between the outer peripheral surface of the convex portion of the forming die S2 and the resin block 6, and thus making it possible to relieve the external force exerted on the root of that convex portion. Therefore, it is possible to soundly maintain the convex portion of the forming die S2 and also possible to repeatedly form the hole 5 with high accuracy. Further, even when the resin block 6 is formed by other methods such as an imprint method, the convex portion of the forming die can be also soundly maintained, and thus the hole 5 can be repeatedly formed with high accuracy. In addition, the problem in terms of accuracy of the alignment of the metal die and the manufacturing of the metal die can be also solved.

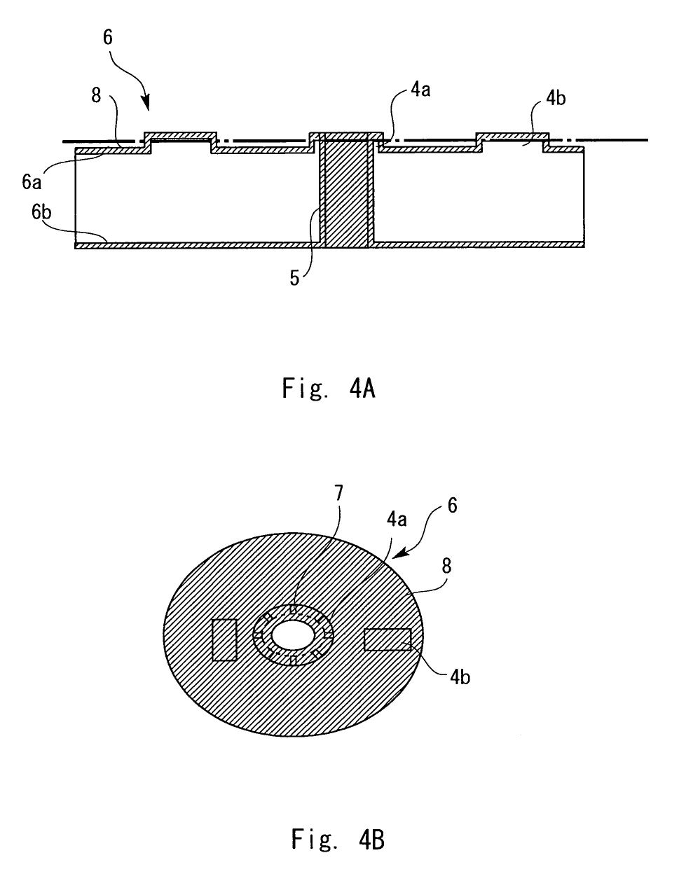

Next, as shown in FIGS. 4A and 4B, a conductive film 8 is formed on the exposed surfaces of the resin block 6. That is, the conductive film 8 is formed on the front and back surfaces, and on the inner peripheral surface of the hole 5 of the resin block 6. At this point, the conductive film 8 is formed by a conductive film formation method such as electroless plating or sputtering. In this way, the conductive film can be formed satisfactory even in the inner peripheral surface of the hole 5. Note that the hatched portion indicates the area where the conductive film 8 is formed in the examples shown in the figures.

The thickness of the conductive film 8 is preferably determined by taking the skin effect of electromagnetic waves in the used band into consideration. For example, the skin effect is about 0.3 μm at 60 GHz, and therefore the conductor loss due to the skin effect becomes negligible when the thickness is about five times as large as that.

Although the conductive film 8 is formed on the front and back surfaces and the inner peripheral surface of the hole 5 of the resin block 6 as the exposed surfaces of the resin block 6, the present invention is not limited to this configuration. A conductive film 8 may be also formed on the side surface of the resin block 6.

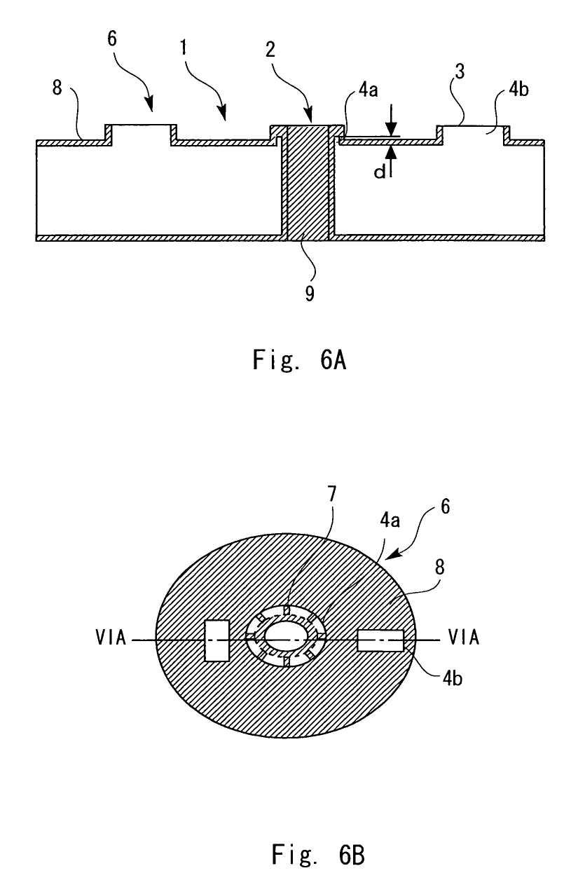

Next, to implement a circuit pattern, the convex portions 4a and 4b are ground or shaved until the upper end faces of the convex portions 4a and 4b are exposed. That is, the convex portions 4a and 4b are removed to the line shown by the dashed line of FIG. 4A. As a result, as shown in FIGS. 5A, 5B, 6A, and 6B, a pattern that functions as a circuit is formed on the convex portion 4b or on a concave portion in the region surrounding the convex portions 4a and 4b. Further, since the conductive film 8 remains in the concave portions 7 in the upper end face of the convex portion 4a, the conductive film 8 located on the front surface of the resin block 6 is electrically connected with the conductive film 8 located on the back surface of the resin block 6 through the through-hole 2.

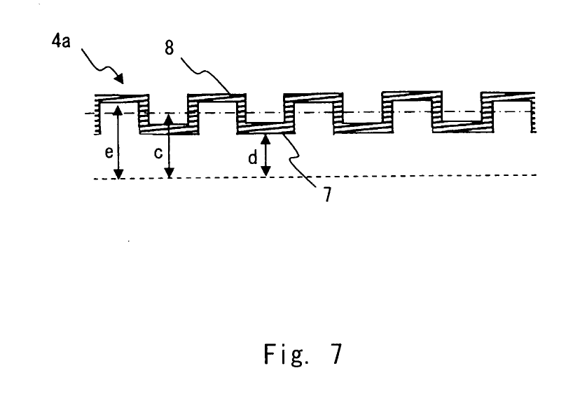

The relation between the height e in FIG. 3A, the height c in FIG. 5A, and the height din FIG. 6A is explained hereinafter with reference to FIG. 7. FIG. 7 is an enlarged peripheral cross-section of the convex portion 4a. The height e shown in FIGS. 3A and 7 represents the height of the convex portion 4a at the time when the pattern is molded. The height c shown in FIGS. 5A and 7 represents the height of the upper end face at the time when the convex portion 4a is ground or shaved to the dashed line of FIG. 4A. The height d shown in FIGS. 6A and 7 represents the height of the top surfaces of the concave portions 7 at the time when the convex portion 4a is ground or shaved to the dashed line of FIG. 4A. As shown in FIG. 7, the relation between these heights are expressed as “e>c>d”.

By creating a circuit component 1 in this manner, the formation of the circuit pattern and the formation of the through-hole can be simultaneously performed. In addition, since the circuit component 1 is created by using a resin molding method, it becomes possible to mass-produce the circuit components 1 having highly-accurate circuit patterns and through-holes. That is, the number of manufacturing processes can be reduced by processing the entire front surface 6a of the resin block 6 in a collective manner, and a through-hole 2 can be formed with high positional accuracy. The accurate position of the through-hole 2 is also important in terms of circuit because it can reduce the variations in characteristics, and therefore the fact that the through-hole 2 is formed in the same process as the circuit pattern has a great significance.

Note that if the grinding or shaving is excessively performed, the circuit pattern surface could be damaged. However, the height of the convex portion 4b before the formation of the conductive film 8 serves as a margin for the amount of the shaving or grinding.

In a circuit component 1 having a through-hole 2 manufactured in the above-described manufacturing method, the resin block 6 is formed by a resin molding method. In the front surface 6a of the resin block 6, the peripheral region including a region where the through-hole 2 is formed is formed as a convex portion 4a. The through-hole 2 is formed within that convex portion 4a, and the conductive films formed on the front and back surfaces of the resin block 6 are electrically connected through that through-hole 2. At this point, in the end face around the opening of the through-hole 2 in the convex portion 4a, the concave portions 7, which connect the inner peripheral edge of that upper end face with the outer peripheral edge of the end face, are formed. A conductive film 8 is formed on the concave portions 7. Since the through-hole 2 is formed by a resin molding method in this manner, it is possible to mass-produce circuit components 1 having highly-accurate through-holes 2.

Exemplary embodiments of a component having a through hole and a method of manufacturing the component in accordance with an exemplary aspect of the present invention have been explained so far. However, various modifications can be made without departing the spirit and scope of the present invention. For example, the circuit component 1 in the above-described exemplary embodiments is not limited to passive circuit components such as micro-strip antennas and slot antennas, and examples of components having through-holes include active circuit components.

From the invention thus described, it will be obvious that the embodiments of the invention may be varied in many ways. Such variations are not to be regarded as a departure from the spirit and scope of the invention, and all such modifications as would be obvious to one skilled in the art are intended for inclusion within the scope of the following claims.

What is claimed is:

1. A method of manufacturing a component having a through-hole comprising:
forming a resin block by a resin molding method such that a peripheral region including a region where a through-hole is formed, and a region where a circuit pattern is formed or a peripheral region other than a region where the circuit pattern is formed are formed as a convex portion or a concave portion in one of front and back surfaces, and the other surface has a hole in a region where the through-hole is formed, an end portion of the hole being accommodated within a convex portion of the region;
removing the convex portion so that the hole completely penetrates the resin block;
forming a conductive film on an exposed surface of the resin block; and
removing the conductive film so that an end face of the convex portion is exposed, and electrically connecting conductive films formed on the front and back surfaces of the resin block through the through-hole.

2. The method of manufacturing a component having a through-hole according to claim 1, wherein
a concave portion is formed in advance on the end face of the convex portion, within which the end portion of the hole is accommodated, the concave portion being configured to connect the inner peripheral edge of the end face with the outer peripheral edge of the end face when the hole completely penetrates the resin block, and
the conductive film formed on the end face of the convex portion is removed such that some of the conductive film remains in that concave portion.

3. The method of manufacturing a component having a through-hole according to claim 1, wherein the resin block is formed by an injection molding method, a nano-imprint method, or a thermal embossing method.

4. The method of manufacturing a component having a through-hole according to claim 1, wherein a circuit pattern in formed as a convex portion or a concave portion.

5. A component having a through-hole, wherein
a resin block is formed by an injection molding method, and
in one of front and back surfaces of the resin block, a peripheral region including a region where a through-hole is formed is formed as a convex portion; a through-hole is formed within the convex portion; and conductive films formed on the front and back surfaces of the resin block are electrically connected through the through-hole.

6. The component having a through-hole according to claim 5, wherein
a concave portion is formed on the end face around the opening portion of the through-hole in the convex portion, the concave portion being configured to connect the inner peripheral edge of the end face with the outer peripheral edge of the end face, and
a conductive film is formed in the concave portion.

7. The component having a through-hole according to claim 5, wherein the resin block is formed by an injection molding method, a nano-imprint method, or a thermal embossing method.

8. The component having a through-hole according to claim 5, wherein the component is a passive component.

9. The component having a through-hole according to claim 6, wherein the component is a passive component.

10. The component having a through-hole according to claim 7, wherein the component is a passive component.
